(19) United States
(12) Patent Application Publication
(10) Pub. No.: US 2011/0067577 A1
(43) Pub. Date: Mar. 24, 2011

(54) COOKTOP GRIDDLE AND BROILER FOR COOKING APPLIANCES

(76) Inventors: Brian S. RIDDLE, Louisville, KY (US); Paul Cadima, Prospect, KY (US); Jason Randall Northcut, Louisville, KY (US); Daniel Joseph Trice, Louisville, KY (US); James Tomaszewski, Louisville, KY (US); Rafael Martinez, Queretaro (MX); Michael Thomas Chezem, Georgetown (IN); Cecil Clay Clements, Louisville, KY (US); Mireya Huerta, Queretaro (MX); Edger Arreortua, Queretaro (MX)

(21) Appl. No.: 12/562,177

(22) Filed: Sep. 18, 2009

(51) Int. Cl. A47J 37/00; F24C 3/00

(52) U.S. Cl. 99/339; 99/422; 99/447; 126/41 R

(57) ABSTRACT

A cooking appliance including a cooktop having a cooktop surface and a griddle system including at least one cooking grate positioned on the cooktop surface, the at least one cooking grate including at least one griddle support protruding therefrom, and a griddle configured to removably engage the at least one griddle support, the at least one griddle support being configured to support the griddle away from the cooktop surface, and/or an oven cavity defined by top, bottom, front, rear, and lateral sides and a broil system including a diffuser disposed adjacent the top side of the oven cavity, a single tube broil element disposed between the diffuser and the top side of the oven cavity, and the diffuser being configured to diffuse heat emitted from the single tube broil element to form a substantially even temperature gradient proximate the top side of the oven cavity.

### BACKGROUND OF THE INVENTION

The present invention relates generally to components for cooking appliances and in particular to cooktop griddles and broilers for cooking appliances.

Generally cooktops of cooking appliances that are designed with griddles are configured so that the griddle rests directly on the cooktop. However, placing the griddle directly on the cooktop may cause the griddle to scratch or otherwise damage the cooktop surface. Some appliance manufacturers have added feet to the bottom of the griddle in an attempt to prevent scratching or damage to the cooktop surface. The feet that are added to the bottom of the griddle are generally constructed of a soft rubber or a soft metal such as copper or aluminum. While the addition of feet may help to prevent damage to the cooktop surface, the feet add additional cost to the griddle (e.g. in labor needed to attach the feet to the griddle as well as additional manufacturing/material costs). Often the griddles become hot enough to melt the material that the feet are made of. Other attempts to prevent damage to a cooktop surface from placement of a griddle on the cooktop include placing separate bumpers on the cooktop surface, where the bumpers function substantially in the same manner as the feet described above to provide a gap between the griddle and the cooktop. However, these bumpers are generally constructed of the same materials as the feet and have substantially the same heat related problems.

It would be advantageous to be able to place a griddle on a cooktop without damaging the cooktop surface and without the drawbacks mentioned above.

It is also known in the art that one of the simplest and most cost effective methods of introducing energy (e.g. in the form of heat) in, for example, the top half of an oven cavity of a gas oven is the use of a single tube broil element. The single tube broil element is generally located towards the top of the oven cavity and centrally located, with respect to side walls of the oven cavity. A single tube broil element is a single substantially straight tube centrally located within an oven cavity for providing fuel through apertures located through the tube. An igniter ignites the fuel forming a substantially straight row of flame centrally located at, for example, the top of the oven cavity. However, the central placement of the single tube broil element generally causes the uneven broiling/cooking of food placed in close proximity to the single tube broil element when the food is spread about a cooking rack placed in the oven cavity. For example, food placed along the sides of the cooking rack cook more slowly than the food placed on the cooking rack substantially beneath the single tube broil element such that the food along the sides of the rack remains uncooked while the food located substantially beneath the single tube broil element are burned.

It would also be advantageous to have a single tube broiling element that is capable of substantially evenly cooking food regardless of its placement on a cooking rack or a position of the cooking rack within the oven cavity.

### BRIEF DESCRIPTION OF THE INVENTION

As described herein, the exemplary embodiments overcome one or more of the above or other disadvantages known in the art.

One aspect of the exemplary embodiments relates to a griddle system for a cooktop of an appliance where the cooktop has a cooktop surface. The griddle system includes at least one cooking grate positioned on the cooktop surface, the at least one cooking grate including at least one griddle support protruding therefrom, and a griddle configured to removably engage the at least one griddle support, where the at least one griddle support is configured to support the griddle away from the cooktop surface.

Another aspect of the exemplary embodiments relates to a broil system for a cooking appliance where the cooking appliance includes an oven cavity defined by a top side, a bottom side, a front side, a rear side, and lateral sides. The broil system includes a diffuser disposed adjacent the top side of the oven cavity, a single tube broil element disposed between the diffuser and the top side of the oven cavity. The diffuser is configured to diffuse heat emitted from the single tube broil element to form a substantially even temperature gradient proximate the top side of the oven cavity between the front, rear and lateral sides.

Still another aspect of the disclosed embodiments relates to a cooking appliance. The cooking appliance includes a cooktop having a cooktop surface and an oven cavity defined by a top side, a bottom side, a front side, a rear side, and lateral sides. The cooking appliance includes a griddle system having at least one cooking grate positioned on the cooktop surface, the at least one cooking grate including at least one griddle support protruding therefrom, and a griddle configured to removably engage the at least one griddle support, where the at least one griddle support is configured to support the griddle away from the cooktop surface. The cooking appliance further includes a broil system having a diffuser disposed adjacent the top side of the oven cavity, a single tube broil element disposed between the diffuser and the top side of the oven cavity, wherein the diffuser is configured to diffuse heat emitted from the single tube broil element to form a substantially even temperature gradient proximate the top side of the oven cavity between the front, rear and lateral.

These as other aspects and advantages of the exemplary embodiments will become more apparent from the following detailed description considered in conjunction with the accompanying drawings. It is to be understood, however, that the drawings are designed solely for the purposes of illustration and not as a definition of the limits of the invention, for which reference should be made to the appended claims. Moreover, the drawings are not necessarily to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a schematic illustration of an exemplary appliance incorporating features in accordance with an exemplary embodiment;

FIG. 2 is a schematic illustration of a portion of the appliance of FIG. 1 in accordance with an exemplary embodiment;

FIGS. 3A-3C are schematic illustrations of portions of cooktop grates in accordance with an exemplary embodiment;

FIGS. 4A-4D are a schematic illustrations of a griddle in accordance with an exemplary embodiment (FIG. 4D is an enlarged side view);

FIGS. 5A-5D are schematic illustrations of portions of the griddle and cooktop grates of the appliance in FIG. 1 in accordance with an exemplary embodiment;

FIG. 6 is a schematic illustration of a portion of an oven of the appliance of FIG. 1 in accordance with an exemplary embodiment;

FIG. 7 is a schematic illustration of the oven in FIG. 6 in accordance with an exemplary embodiment;

FIGS. 8A and 8B are schematic illustrations of a portion of the oven of the appliance of FIG. 1 in accordance with an exemplary embodiment;

FIG. 9A is an exemplary oven heat distribution of a conventional oven having a single tube broil element;

FIGS. 9B-9D are exemplary graphs of oven heat distributions in accordance with an exemplary embodiment;

FIG. 10A is an exemplary illustration of a broil pattern in of a conventional oven having a single tube broil element; and

FIG. 10B is an exemplary illustration of a broil pattern in accordance with an exemplary embodiment.

### DETAILED DESCRIPTION OF THE EXEMPLARY EMBODIMENTS OF THE INVENTION

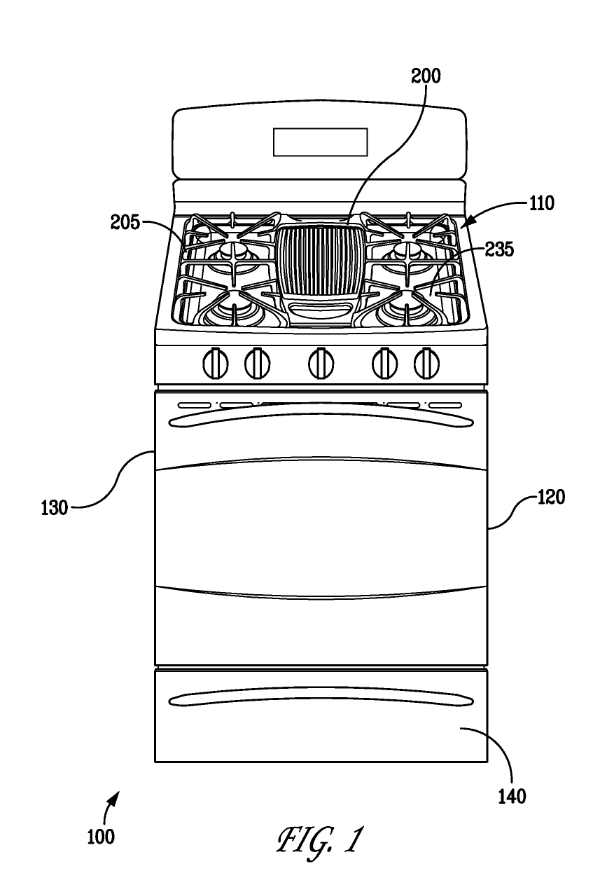

In one exemplary embodiment, referring to FIG. 1, a cooking appliance 100 is provided. Although the embodiments disclosed will be described with reference to the drawings, it should be understood that the embodiments disclosed can be embodied in many alternate forms. In addition, any suitable size, shape or type of elements or materials could be used. In the examples described herein, the cooking appliance 100 is configured as a free standing range. However, it should be understood that while the exemplary embodiments are described herein with respect to a free standing range, the aspects of the exemplary embodiments may be applied to any suitable cooking appliance having any suitable cooktop and/or oven in a manner substantially similar to that described herein.

In one aspect, the exemplary embodiments provide a cooking appliance 100 having a griddle that can be placed on the cooktop 110 without contacting the cooktop surface 235. In accordance with an exemplary embodiment, the cooktop 110 may include one or more cooking grates 205 configured to engage at least a portion of the griddle 200 in any suitable manner for stably supporting the griddle 200 away from the cooktop surface 235 so that the griddle 200 may be placed on and removed from the cooktop surface 235 substantially without damaging the cooktop surface 235.

In another aspect, the exemplary embodiments provide the cooking appliance 100 with an oven 120 having a single tube broil element. The oven 120 includes a diffuser that is configured to apply a substantially even heat gradient to food being broiled/cooked in close proximity to the single tube broil element.

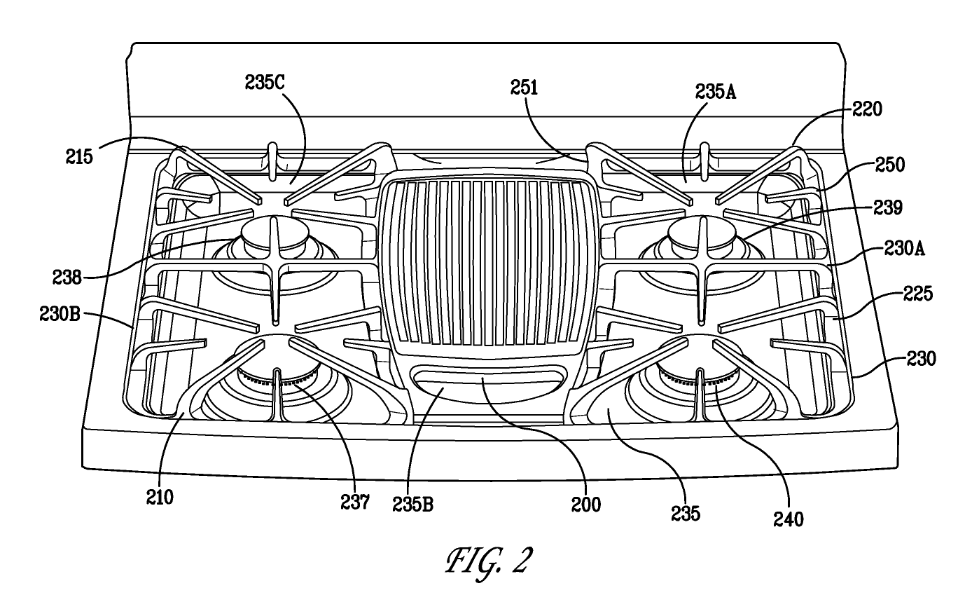

In the exemplary embodiment of FIG. 1, the cooking appliance 100 includes a frame or housing 130. The housing 130 forms internal cavities such as the cavity of the oven 120 or drawer/mini-oven 140 for storing/baking items. In this example, the cooking appliance 100 is in the form of a gas operated free standing range having a cooktop 110 and an oven 120. In alternate embodiments, the cooking appliance 100 may be any suitable cooking appliance. Referring also to FIG. 2, the cooktop 110 includes a cooktop surface 235, portions of which may be recessed 235A-235C to at least partly house respective burners 237-230. In this embodiment, the cooktop surface 235 includes a shelf 230 disposed around a periphery of each of the recesses 235A-235C. The shelf 230 is configured to support and positionally locate one or more cooking grates 205. For example, a first shelf 230A is disposed around a periphery of recess 235A for supporting and locating a right rear grate 220 and a right front grate 230. A second shelf 230B is disposed around a periphery of recess 235C for supporting and locating a left rear grate 215 and a left front grate 210. It is noted that portions of the shelves 230A, 230B may also be disposed along at least a portion of the periphery of recess 235B. The terms right and left (and front, back, rear and any other spatially related terms) are used herein for exemplary purposes only and any suitable terms may be used to describe the one or more sides (or other portions) of the cooktop 110 in accordance with the exemplary embodiments.

Recess 235B is configured to at least partially house at least one burner (not shown) for the griddle 200. In alternate embodiments, the shelf 230 may have any suitable configuration for supporting and locating the grates 210, 215, 220, 225 and or the griddle 200 in any suitable manner. For exemplary purposes only, the grates 220, 225 on the right side of the cooktop 110 are described as being integrally formed with each other to form a single grate having multiple cooking surfaces.

Still referring to FIG. 2, grates 210, 215, 220 and 225 are substantially similar to each other in form and construction unless otherwise noted. For exemplary purposes, the aspects of the disclosed embodiments will be described with respect to grate 220, although the described features apply equally to grates 210, 215 and 225. Grate 220 has a first side 250 and a second side 251. At least one of the first and second sides 250, 251 has a shape that is complimentary to at least a portion of the griddle 200. In the embodiment of FIG. 2, the second side 251 of grate 220 has an arcuate shape configured to substantially conform to an arcuate shape of the griddle 200. In other examples, the sides 250, 251 of the grates may have any suitable shapes for suitably supporting the griddle 200 in accordance with aspects of the exemplary embodiments.

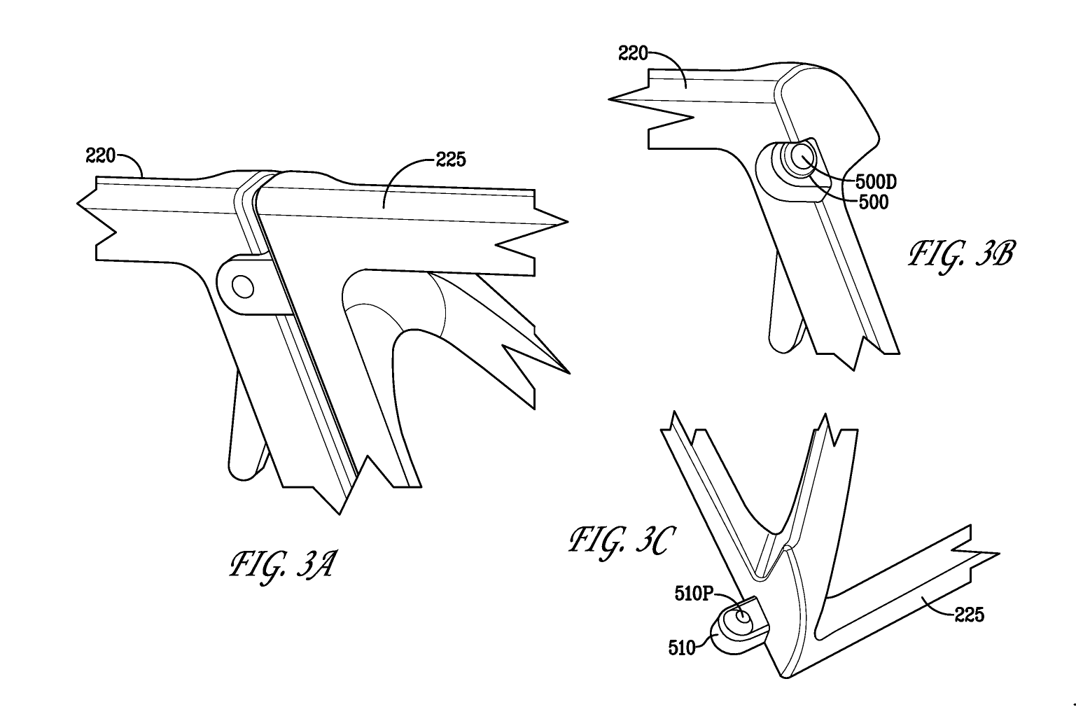

Referring also to FIGS. 3A-3C, grates 220, 225 are shown as being positionally fixed with respect to each other in any suitable manner. Grates 210 and 215 can be similarly fixed or connected. In this embodiment, grate 220 includes one or more suitably shaped recessed engagement members 500 integrally formed therewith. Each recessed engagement member 500 includes a locator 500D, which may have any suitable configuration. For exemplary purposes only, the locator 500D may have a concave, conical or other suitable recessed shape for engaging a corresponding locating feature of grate 225. In the embodiment of FIG. 3, the grate 225 includes one or more protruding engagement members 510 integrally formed therewith. Each protruding engagement member 510 includes a protrusion 510P extending from the protruding engagement member in a direction suitable for engaging the locator 500D of the recessed engagement member 500 of the grate 220. The grates 220, 225 are placed on the support shelf 230 such that the recessed engagement feature 500 of grate 220 is placed over the protruding engagement feature 510 of grate 225 so that the protrusion 510P engages the locator 500D for stationarily fixing the grates 220, 225 relative to each other.

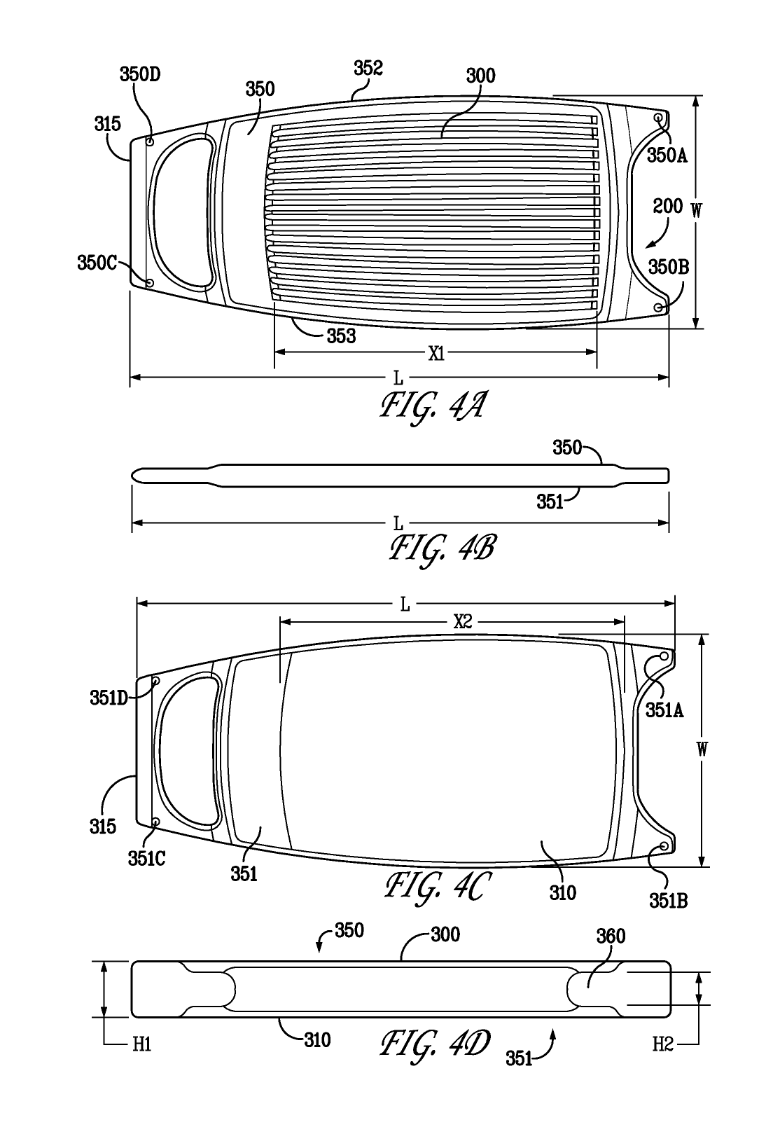

FIGS. 4A-4D illustrate various views of griddle 200. The griddle 200 may have any suitable shape and be constructed of any suitable material(s) capable of withstanding cooking temperatures. The griddle 200 may be constructed of cast-iron or any other suitable metal. The griddle 200 also has a suitable length L, width W and height H1. In one example, the dimensions of the griddle are such that the griddle 200 has a cooking surface of about 99.25 in². In other examples, the cooking area may be more or less than 99.25 in². The griddle 200 generally includes a first surface 350 and an opposing second surface 351. The first and second surfaces 350, 351 of the griddle respectively include one or more recesses 350A-350D, 351A-351D for engaging the grates 210, 215, 220, 225 for supporting and positionally locating the griddle 200 as will be described in greater detail below.

The first surface 350 of the griddle 200 includes a first cooking surface 300 that has a generally grated configuration to, for example, grill foods. The first cooking surface 300 may have any suitable dimensions X1, W. The second surface 351 of the griddle 200 includes a second cooking surface 310 that has a substantially smooth configuration to, for example, fry foods. The second cooking surface 310 may also have any suitable dimensions X2, W, one or more of which may be the same or different than the dimensions of the first cooking surface 300. In one example, the first cooking surface 300 of the first surface 350 may have the same or a different surface area than the second cooking surface 310 of the second surface 351. The first and second cooking surfaces 300, 310 may be substantially recessed relative to a respective surface 350, 351 of the griddle 200 such that a web 360 of griddle material between the surfaces 350, 351 has a suitable thickness H2 for providing a uniform heat distribution throughout the cooking surfaces 300, 310.

In the embodiment of FIGS. 1-4, the griddle 200 is a reversible griddle and has two opposing cooking surfaces where either of the first and second surfaces 350, 351 may be selectively used to cook foods. The griddle also includes a handle 315 disposed at an end of the griddle 200. In other examples, there may be one or more handles suitably located at any position (e.g. front, back and/or sides) on the griddle 200. As can be seen in FIGS. 4A and 4C, sides 352, 353 of the griddle 200 have an arcuate shape that is complimentary to the shape of the second sides 251 of the grates 210, 215, 220, 225. In alternate embodiments, the sides 352, 353 of the grate 200 may have any suitable shape complimentary to the second sides 251 of the grates 210, 215, 220, 225.

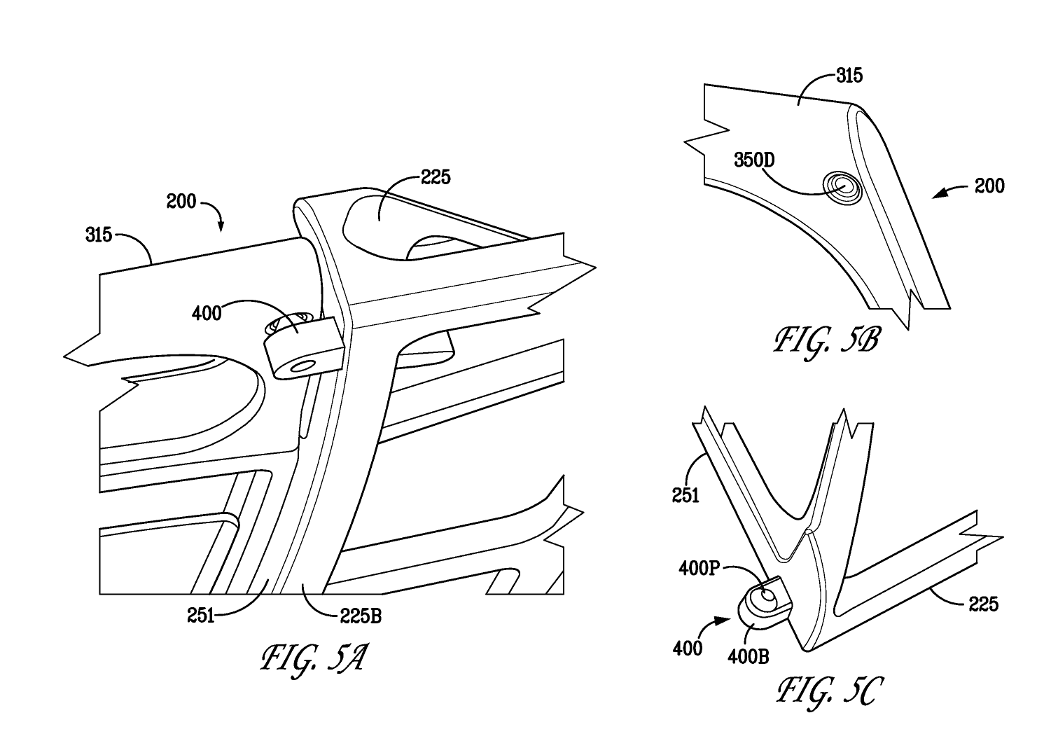

Referring to FIGS. 5A-5D, the interface between the griddle 200 and the grates 210, 215, 220, 225 will be described. It is noted that while grate 225 is used in describing the interface between the griddle 200 and grates 210, 215, 220, 225, grates 210, 215, 220 include substantially similar features to those described with respect to grate 225, unless otherwise noted. Grate 225 has a griddle support 400 integrally formed therewith. The griddle support 400 generally includes a base 400B and a protrusion 400P. A bottom of the base 400 is substantially coplanar with a bottom 225B of the grate 225. In alternate embodiments, the bottom of the base 400B may have any spatial relationship relative to the bottom 225 of the grate 225.

The base 400B is configured to extend away from the second side 251 of the grate 225. The protrusion 400P may have a substantially convex, conical or other suitable shape that extends away from the base 400B in a direction suitable for engaging the griddle 200. In other examples, the griddle support 400 may have any suitable shape and configuration for supporting the griddle 200.

As described above, the griddle 200 includes one or more recesses 350A-350D and 351A-351D. For exemplary and descriptive purposes, only recess 350D will be used in describing the interface between the griddle 200 and the grates 210, 215, 220, 225. However, it should be understood that the other recesses 350A-350C and 351A-351D may have a substantially similar form and configuration unless otherwise noted. In this example, the recess 350D has a substantially concave, conical or other suitable shape that is complimentary to the shape of the protrusion 400P so that as the griddle 200 is placed onto the cooktop 110 (FIG. 1), at least a portion of the protrusion 400P engages the recess 350D for stably holding and positioning the griddle 200 on the cooktop 110. In other examples, the griddle support 400 may include a recess similar to recess 350D and the griddle 200 may include a protrusion similar to protrusion 400P for stably supporting and locating the griddle on the cooktop 110 in a manner substantially similar to that describe above. It is noted that the griddle 200 does not contact the cooktop surface 235 (FIG. 2). Rather, the griddle 200 rests on the cooking grates 205 (which may be held substantially stationary relative to each other by the shelf 230 (FIG. 2) and/or engagement members 500, 510 (FIGS. 3A-3C)) away from the cooktop surface 235 such that the griddle 200 can be removed from and placed on the cooktop 110 without scratching or otherwise damaging the cooktop surface 235. The protrusions 400P of the griddle supports 400 and the recesses 350A-350D, 351A-351D are shaped and dimensioned so that the griddle 200, while disposed on the cooktop 110, is located a distance D2 away from the cooktop surface 235 and a distance D1 away from an edge of the shelf 230 (FIG. 5D). In one embodiment, distance D1 may be about 0.182 inches and the distance D2 may be about 0.380 inches. In alternate embodiments, any suitable distances can be used for D1 and D2.

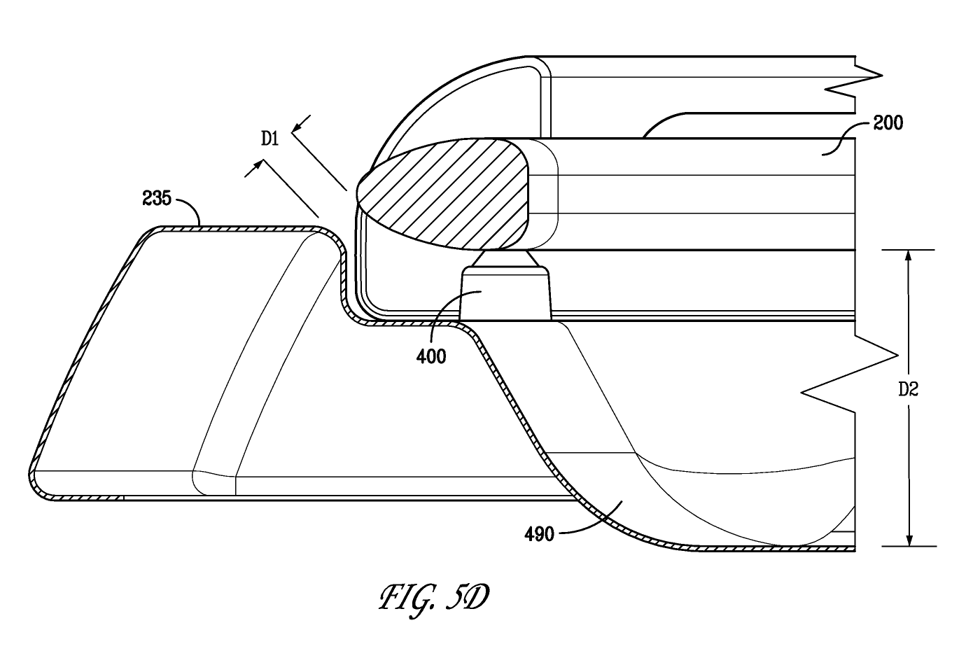

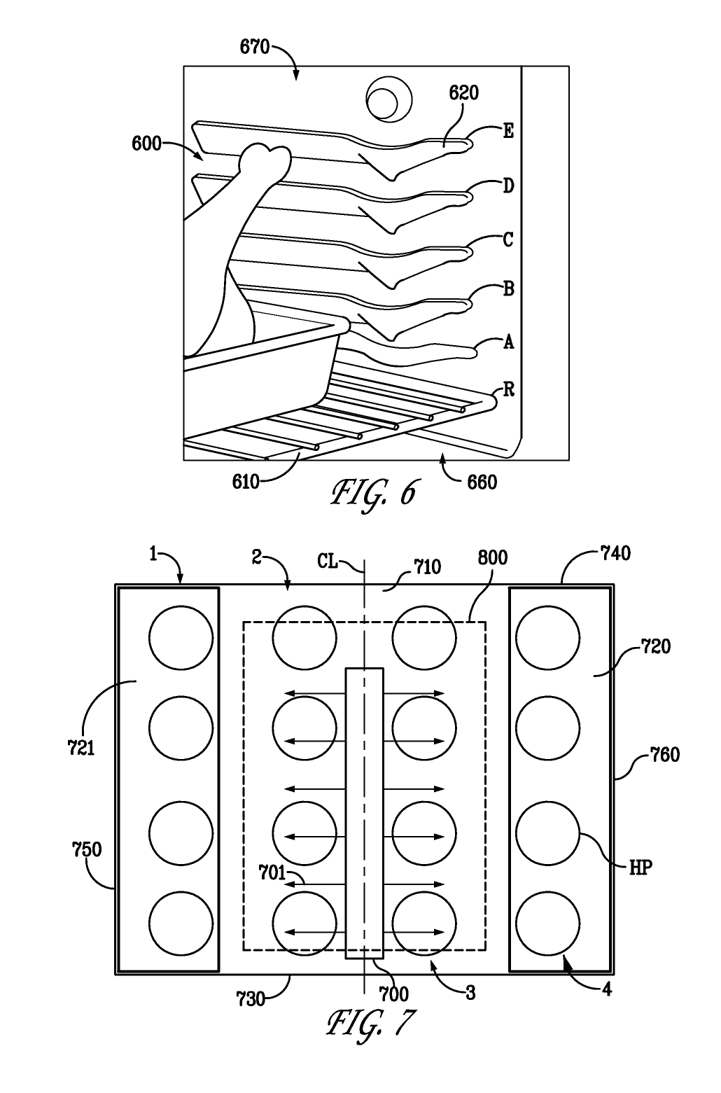

Referring to FIGS. 6 and 7, the oven 120 of FIG. 1 includes an internal cavity 600. The internal cavity 600 is defined by a top side 670, a bottom side 660, a front side 730, a rear side 740, and lateral sides 750, 760. The oven cavity 600 may have any suitable dimensions and includes one or more rack supports 620 located at positions E, D, C, B, A, R, where position E is closest to the single tube broil element (not shown in FIG. 6) (e.g. the top side 670 of the oven cavity) and position R is the closest to the bottom side 660 of the oven cavity 600. One or more racks 610 may be placed in a respective one of the positions E, D, C, B, A, R so that food may be placed on the rack(s) 610 for cooking.

Referring to FIG. 7, the oven cavity 600 of FIG. 6 is shown as being divided into an inner broil zone 710 and outer broil zones 720, 721. As an example, hamburger patties HP are shown as being arranged for cooking in four rows 1-4 on a rack 610 (FIG. 6) that is closest to the single tube broil element 700, e.g. in position E (FIG. 6). Generally, with a conventional single tube broil element, the outer broil zones 720, 721 are significantly cooler than the inner broil zone 710 leaving the food, such as the hamburger patties HP in the outer broil zones (e.g. rows 1 and 4) partially cooked or uncooked, while the hamburger patties HP in the inner broil zone 710 (e.g. rows 3 and 4) are seared or browned.

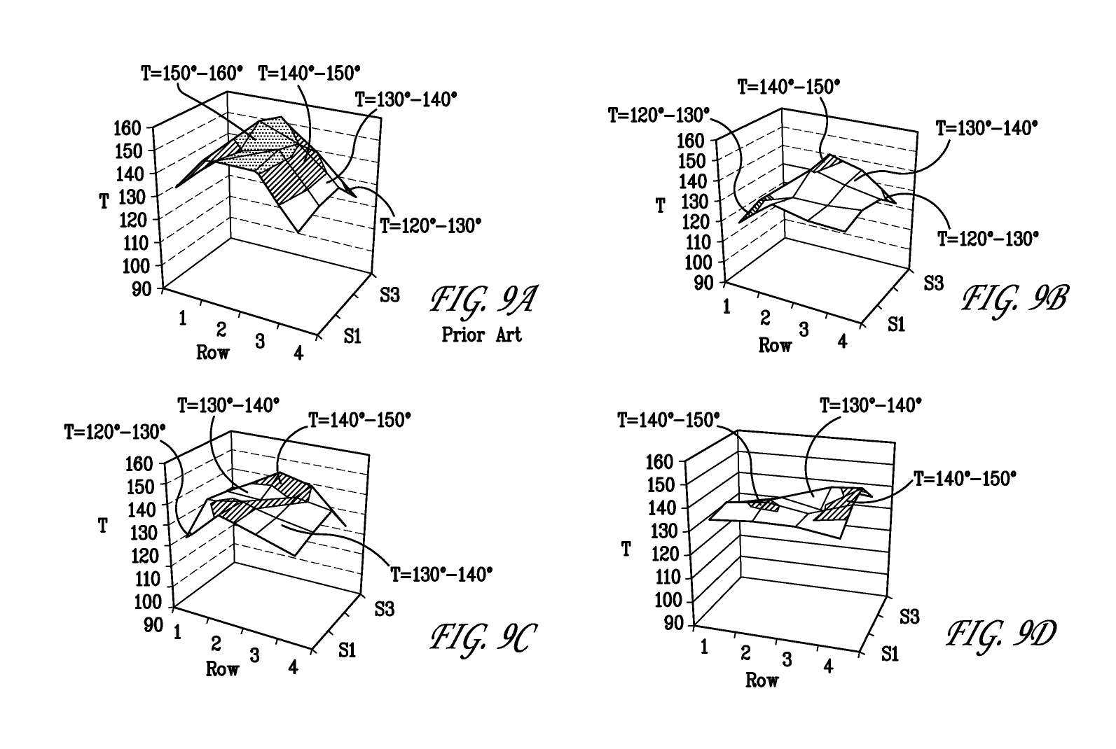

FIG. 9A illustrates a temperature gradient plot for the hamburger patties HP of FIG. 7 in a conventional oven with a single tube broil element. In the plot, T is the temperature, the numbers 1-4 represent the rows 1-4 of hamburger patties HP, S1 represents the front side 730 of the oven cavity and S3 represents the rear side 740 of the oven cavity. As can be seen in FIG. 9A, the temperature gradient falls sharply between rows 2 and 1 towards the lateral side 750 of the oven cavity and between rows 3 and 4 towards the lateral side 760 of the oven cavity leaving the food in rows 1 and 4 substantially uncooked (e.g. not seared or browned).

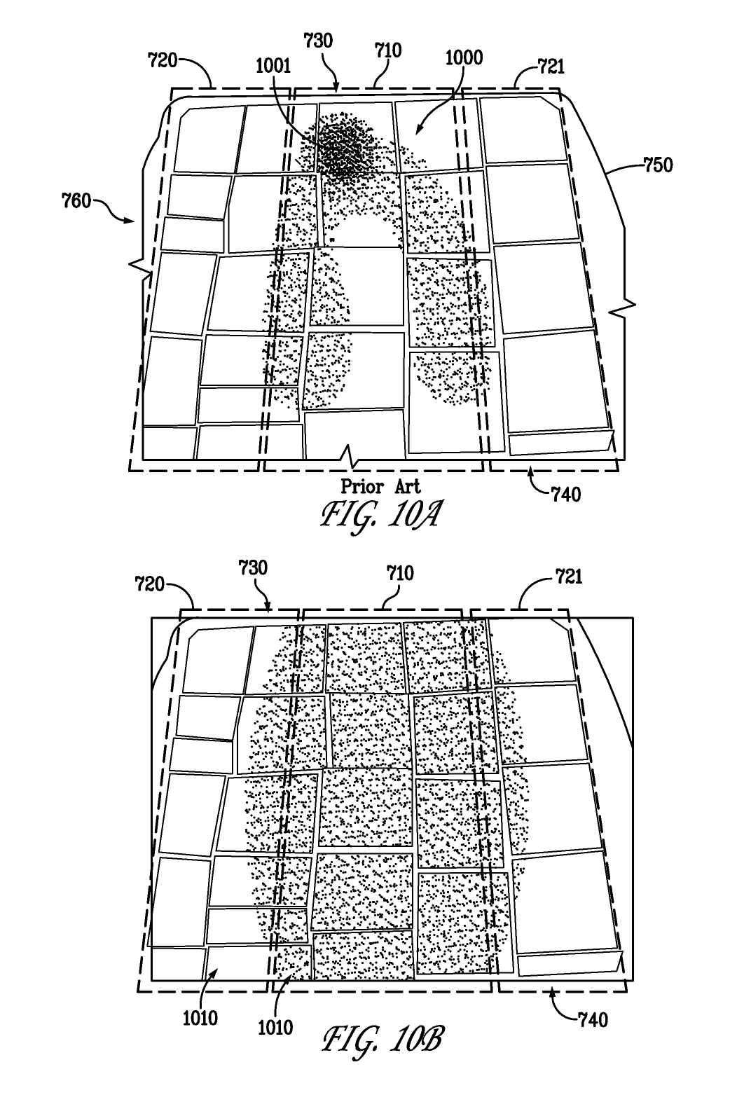

As another example, FIG. 10A shows slices of bread arranged in a manner similar to the hamburger patties HP of FIG. 6. The toasting pattern 1000 of the single tube broil element shows that the slices of bread in the inner broil zone 710 are toasted, while the slices of bread in the outer broil zones 720, 721 remain substantially untoasted. In addition, FIG. 10A shows an igniter burn spot 1001 formed by the locally high temperatures adjacent the igniter. It is noted that the igniter may be placed adjacent the single tube broil element 700 to ignite the fuel (e.g. gas) emitted from the single tube broil element 700.

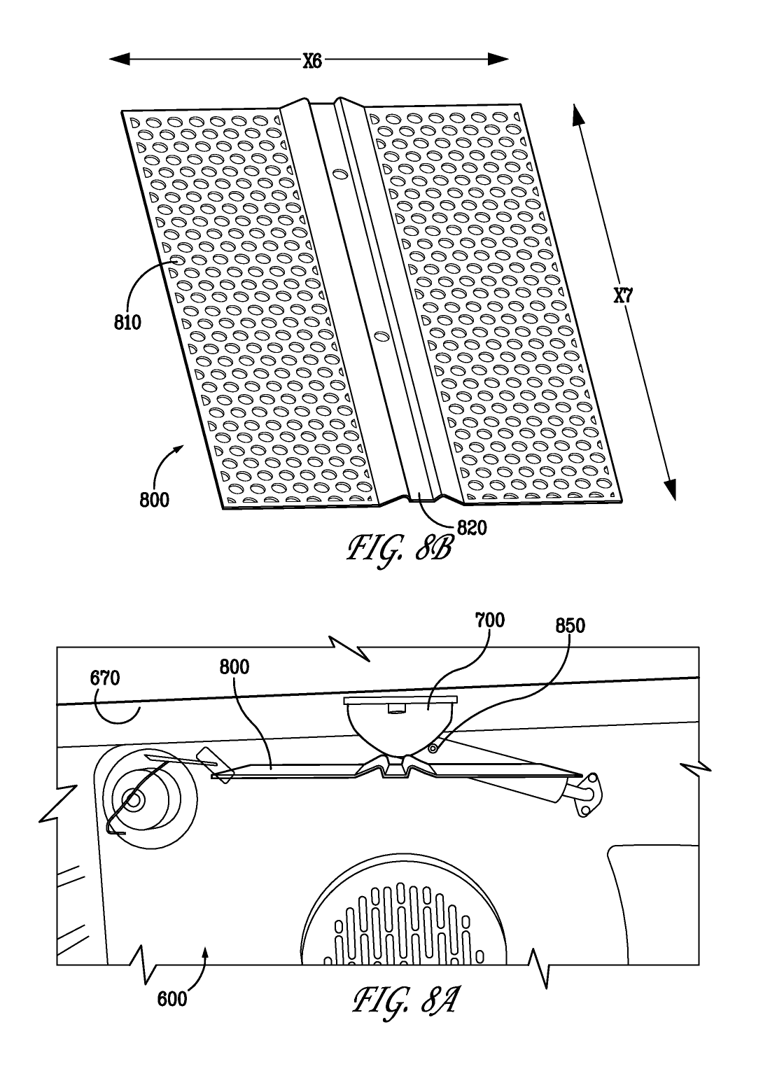

In the embodiment, illustrated in FIG. 7 and FIGS. 8A and 8B, a diffuser 800 constructed of stainless steel is shown suitably mounted within the oven cavity 600. The diffuser 800 may alternatively be constructed of any other suitable material such as, for example, aluminum, and have any suitable shape and size. In the example of FIG. 8, the diffuser 800 is a substantially flat plate that is mounted adjacent a bottom of the single tube broil element 700. The diffuser 800 is locally contoured to facilitate mounting the diffuser 800 in the oven cavity 600. In FIG. 8, the diffuser 800 has a mounting contour 820 that is configured to allow the diffuser 800 to be mounted to the bottom of the single tube broil element 700 such that the mounting contour 820 conforms to a shape of the single tube broil element 700. In other examples, the diffuser 800 may be mounted within the oven cavity 600 relative to the broil element with any suitable brackets or other suitable supports.

As shown in FIG. 8B, the diffuser 800 has a first dimension X7 so that the diffuser 800 extends mainly towards the front side 730 and rear side 740 of the oven cavity 600, as well as a performance driven second dimension X6 extending the diffuser 800 towards the lateral sides 750, 760 of the oven cavity 600. The dimension X7 dictates or controls the temperature gradient between the front side 730 and the rear side 740 of the oven cavity while the dimension X6 dictates or controls the temperature gradient between a center CL and lateral sides 750, 760 of the oven cavity 600. In this example, the mounting contour 820 is shown as being substantially centralized with respect to the second dimension X6 so that the diffuser extends substantially the same distance laterally towards the lateral sides 720, 721 of the oven cavity 600 relative to a mounting location of the diffuser 800. In other examples, the mounting contour 820 may be biased to one side of the diffuser 800 for any suitable purpose, such as to accommodate a mounting location, a shape of the oven cavity or to obtain any suitable temperature gradient within the oven cavity when broiling.

The diffuser 800 includes one or more apertures 810 for allowing heat 701 to pass through the diffuser 800. The apertures 810 may have any suitable shape including, but not limited to, round, diamond, triangular, square, rectangular or any other suitable geometrical shape. In this example, a ratio between the amount of diffuser material (e.g. the solid parts of the diffuser) and the apertures 810 (merely surface area comparison) is between about 2.5 to 1, and about 2.75 to 1 for a single tube broil element 700 rated at about 13.5K Btu. It should be understood that the ratio between the amount of diffuser material and the apertures 810 will change with respect to higher or lower broiler Btu ratings to obtain a substantially even broiling temperature gradient throughout the oven cavity 600. The geometry of the diffuser 800 and the apertures 810 passing through the diffuser 800 allow a predetermined amount of heat to pass through the diffuser 800 to create a substantially even heat pattern or gradient for broiling foods proximate the top side 670 of the oven cavity 600 and substantially adjacent the single tube broil element 700.

FIGS. 9B-9D illustrate temperature gradient plots for the hamburger patties HP shown in FIG. 7, when broiled using the diffuser 800 in accordance with the exemplary embodiments. In the plots, T is the temperature, the numbers 1-4 represent the rows 1-4 of hamburgers HP, S1 represents the front side 730 of the oven cavity and S3 represents the rear side 740 of the oven cavity. The temperature gradients shown in FIGS. 9B-9D using the single tube broil element 700 with the diffuser 800 are significantly more uniform than the temperature gradient shown in FIG. 9A with respect to the conventional single tube broil element (the variation of the gradients shown in FIGS. 9B-9D relative to each other is caused mainly by factors such as the variation in the test specimen, the variation in the location of the test specimen, etc.). This substantially even temperature gradient allows food within the oven cavity to be moved closer to the broil element, while cooking (e.g. searing and/or browning) more evenly than with conventional broiler designs.

As an example, FIG. 10B shows slices of bread arranged in a manner similar to the hamburger patties HP. The toasting pattern 1010 of the single tube broil element 700 with the diffuser 800 in accordance with aspects of the exemplary embodiments formed on the bread is shown in FIG. 10b. The toasting pattern 1010 is substantially evenly distributed throughout the inner broil zone 710 and the outer broil zones 720, 721. It is noted that the igniter 850 (FIG. 8A) for the single tube broil element 700 is be placed between the top of the oven cavity and the diffuser 800 to substantially prevent locally increased temperatures that causes burning of the food being broiled in the area of the igniter (see e.g. igniter burn spot 1001 in FIG. 10A and the substantial absence of any igniter burn spot in FIG. 10B).

Thus, while there have been shown and described and pointed out fundamental novel features of the invention as applied to the exemplary embodiments thereof, it will be understood that various omission and substitutions and changes in the form and details of devices illustrated, and in their operation, may be made by those skilled in the art without departing from the spirit of the invention. For example, it is expressly intended that all combinations of those elements and/or method steps, which perform substantially the same way to achieve the same results, are with the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A griddle system for a cooktop of an appliance, the cooktop having a cooktop surface, the griddle system comprising:
at least one cooking grate positioned on the cooktop surface, the at least one cooking grate including at least one griddle support protruding therefrom; and
a griddle configured to removably engage the at least one griddle support, where the at least one griddle support is configured to support the griddle away from the cooktop surface.

2. The griddle system of claim 1, wherein the at least one griddle support comprises at least one protrusion and the griddle comprises at least one recess, the at least one recess in the griddle being configured to engage a corresponding one of the at least one protrusion of the griddle support for stably holding and locating the griddle relative to the cooktop surface.

3. The griddle system of claim 1, wherein the at least one cooking grate comprises a plurality of cooking grates, at least one of the plurality of cooking grates comprising a protruding engagement member and at least another of the plurality of cooking grates comprising a recessed engagement member, the recessed engagement member and protruding engagement member being configured to engage one another for positioning the at least one of the plurality of cooking grates and the at least another of the plurality of cooking grates relative to each other.

4. The griddle system of claim 1, wherein the griddle is a reversible griddle comprising two opposing cooking surfaces, each cooking surface being located on a different surface of the griddle.

5. The griddle system of claim 1, wherein the at least one cooking grate has a contoured side and the griddle has a contoured side, the contoured side of the griddle having a shape that is complimentary to the contoured side of the at least one cooking grate.

6. The griddle system of claim 1, wherein the at least one griddle support is integrally formed as a single unit with a corresponding one of the at least one cooking grate.

7. A broil system for a cooking appliance, the cooking appliance including an oven cavity defined by a top side, a bottom side, a front side, a rear side, and lateral sides, the broil system comprising:
a diffuser disposed adjacent the top side of the oven cavity; and
a single tube broil element disposed between the diffuser and the top side of the oven cavity,
wherein the diffuser is configured to diffuse heat emitted from the single tube broil element to form a substantially even temperature gradient proximate the top side of the oven cavity between the front, rear and lateral sides.

8. The broil system of claim 7, wherein the diffuser comprises a plate.

9. The broil system of claim 8, wherein the diffuser has a plurality of apertures running through the plate, a ratio between an amount of diffuser material and the apertures being between about 2.5 to 1 and about 2.75 to 1.

10. The broil system of claim 7, further comprising an igniter disposed adjacent the single tube broil element between the top side of the oven cavity and the diffuser.

11. The broil system of claim 7, wherein the diffuser includes a mounting contour that conforms to a shape of the single tube broil element, the mounting contour effecting placement of the diffuser adjacent the single tube broiling element.

12. The broil system of claim 7, wherein the diffuser comprises a first dimension and a second dimension, the first dimension substantially controlling a temperature gradient between the front and rear sides of the oven cavity and the second dimension substantially controlling a temperature gradient between a location of diffuser adjacent the single tube broiling element and each one of the lateral sides.

13. A cooking appliance comprising:
a cooktop having a cooktop surface and an oven cavity defined by a top side, a bottom side, a front side, a rear side, and lateral sides;
a griddle system comprising,
at least one cooking grate positioned on the cooktop surface, the at least one cooking grate including at least one griddle support protruding therefrom, and
a griddle configured to removably engage the at least one griddle support, where the at least one griddle support is configured to support the griddle away from the cooktop surface; and
a broil system comprising,
a diffuser disposed adjacent the top side of the oven cavity; and
a single tube broil element disposed between the diffuser and the top side of the oven cavity,
wherein the diffuser is configured to diffuse heat emitted from the single tube broil element to form a substantially even temperature gradient proximate the top side of the oven cavity between the front, rear and lateral sides.

14. The cooking appliance of claim 13, wherein the griddle support comprises at least one protrusion and the griddle comprises at least one recess, the at least one recess in the griddle being configured to engage a corresponding one of the at least one protrusion of the griddle support for stably holding and locating the griddle relative to the cooktop surface.

15. The cooking appliance of claim 13, wherein the at least one cooking grate comprises a plurality of cooking grates, at least one of the plurality of cooking grates comprising a protruding engagement member and at least another of the plurality of cooking grates comprising a recessed engagement member, the recessed engagement member and protruding engagement member being configured to engage one another for positioning the at least one of the plurality of cooking grates and the at least another of the plurality of cooking grates relative to each other.

16. The cooking appliance of claim 13, wherein the at least one griddle support is integrally formed as a single unit with a corresponding one of the at least one cooking grate.

17. The cooking appliance of claim 13, wherein the oven cavity, the diffuser comprises a plate.

18. The cooking appliance of claim 17, wherein the diffuser comprises a plurality of apertures running through the plate, a ratio between an amount of diffuser material and the apertures being between about 2.5 to 1 and about 2.75 to 1.

19. The cooking appliance of claim 13, wherein further comprising an igniter disposed adjacent the single tube broil element between the top side of the oven cavity and the diffuser.

20. The cooking appliance of claim 13, wherein the diffuser comprises a first dimension and a second dimension, the first dimension substantially controlling a temperature gradient between the front and rear sides of the oven cavity and the second dimension substantially controlling a temperature gradient between a location of diffuser adjacent the single tube broiling element and each one of the lateral sides.
